(19) United States
(12) Patent Application Publication
(10) Pub. No.: US 2026/0217171 A1
(43) Pub. Date: Jul. 30, 2026

(54) MODULAR SQUAB CUSHION

(71) Applicant: FAURECIA Sièges d'Automobile, NANTERRE (FR)

(72) Inventor: Jeremy GALMICHE, VALLEROIS-LORIOZ (FR)

(21) Appl. No.: 19/459,475

(22) Filed: Jan. 26, 2026

(30) Foreign Application Priority Data
Jan. 29, 2025 (FR) 2500935

(51) Int. Cl. B60N 2/64; B60N 2/68

(52) U.S. Cl. CPC B60N 2/646; B60N 2/68

(57) ABSTRACT

A modular squab cushion configured to be attached to a squab structure, the modular squab cushion comprising a support frame made of a plastic material, and a suspension member attached to the support frame and arranged in whole or in part inside the support frame, the suspension member being made of a plastic material and comprising one or more recesses.

### PRIORITY CLAIM

This application claims priority to French Patent Application No. FR2500935, filed January 29, 2025, which is expressly incorporated by reference herein.

### BACKGROUND

The present disclosure relates to a modular squab cushion. The present description relates to a seat assembly, notably for a motor vehicle, comprising such a modular squab cushion.

### SUMMARY

According to the present disclosure, a modular squab cushion is proposed, configured to be attached to a squab structure, the modular squab cushion comprising:

a support frame made of a plastic material, and

a suspension member attached to the support frame and arranged in whole or in part inside the support frame, the suspension member being made of a plastic material and comprising one or more recesses.

The suspension member can comprise a central plate arranged inside the support frame, the central plate of the suspension member having a greater elastic deformability than the support frame, each recess of the suspension member preferably being formed through the central plate.

At least one, and preferably each, of the one or more recesses of the suspension member may be, in whole or in part, through-going.

At least one, or even each, of the one or more recesses may have a generally elongated shape in a longitudinal direction.

The one or more recesses may comprise at least one row of recesses, the recesses of the at least one row being arranged one after the other in a transverse direction.

The suspension member may comprise one or more mounting lugs by means of which the mounting member is connected to the support frame.

The central plate of the suspension member may comprise one or more folds.

At least one, or even each, of the one or more folds may extend substantially in a transverse direction.

The one or more folds may comprise, in a longitudinal direction, at least one of one or more front folds, and one or more rear folds.

The suspension member may be a single piece.

The recesses present in the suspension member may represent between 20% and 80% of the surface area of the central plate, more specifically between 20% and 30%, between 30% and 40%, between 40% and 50%, between 50% and 60%, between 60% and 70%, or between 70% and 80%.

The one or more recesses may comprise at least one recess of a second type having an oblong or oval shape.

At least one, or even each, of the one or more recesses may have a generally elongated shape in the longitudinal direction X.

The one or more recesses may comprise at least one recess of a third type which longitudinally comprises a first portion and a second portion, the first portion having a transverse dimension greater than that of the second portion.

The one or more recesses may comprise at least one recess of a fourth type which comprises front and rear end portions each having a circular or oval shape and a longitudinally elongated central portion.

According to another aspect, a seat assembly is proposed, in particular for a motor vehicle, comprising the modular squab cushion as described above and a squab structure which comprises two lateral flanges braced by a front tube, and wherein the support frame is attached to the front tube of the squab structure.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic perspective view which shows a modular squab cushion according to a first embodiment of the present disclosure.

FIG. 2 is a schematic cross-sectional view which shows the modular squab cushion according to the first embodiment of the present disclosure.

FIG. 3 is a schematic perspective view which shows a modular squab cushion according to a second embodiment of the present disclosure.

FIG. 4 is a schematic cross-sectional view which shows the modular squab cushion according to the second embodiment of the present disclosure.

FIG. 5 is a schematic perspective view which shows a modular squab cushion according to a third embodiment of the present disclosure.

FIG. 6 is a schematic cross-sectional view which shows the modular squab cushion according to the third embodiment of the present disclosure.

FIG. 7 is a schematic perspective view which shows a modular squab cushion according to a fourth embodiment of the present disclosure.

FIG. 8 is a schematic cross-sectional view which shows the modular squab cushion according to the fourth embodiment of the present disclosure.

FIG. 9 is an exploded and perspective schematic of a seat assembly comprising a modular seat squab according to the present disclosure.

### DETAILED DESCRIPTION

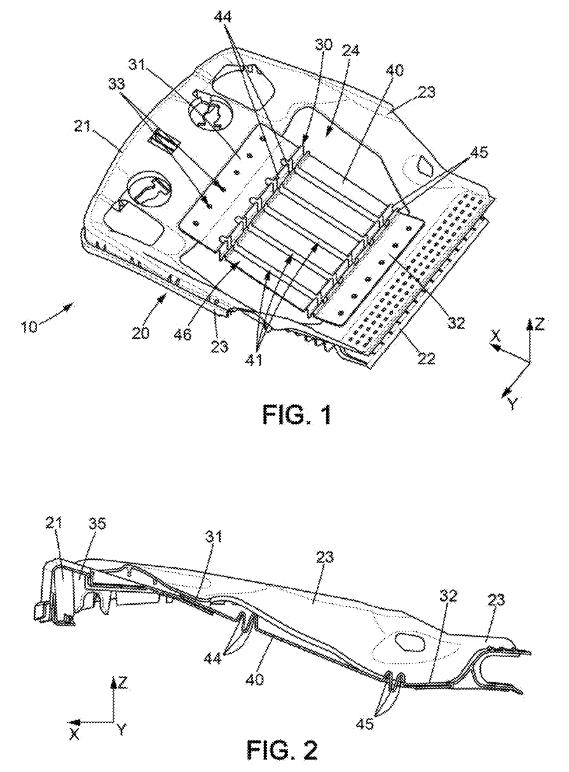

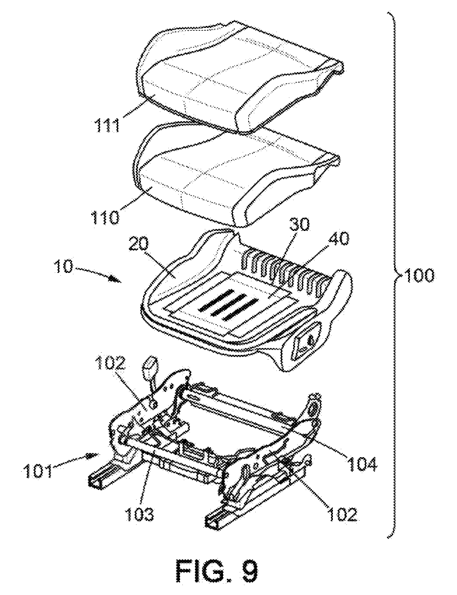

A modular squab cushion is now described, configured to be attached to a seat structure or a seat squab structure, referring to FIGS. 1 to 8.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or the seat in its normal position of use.

In the following, the longitudinal direction X means the longitudinal direction X of the seat. The longitudinal direction X of the seat is considered to be the same as the longitudinal direction X of the motor vehicle V wherein the seat is mounted. This longitudinal direction X corresponds to the normal direction of travel of the vehicle V. The longitudinal direction X is preferably horizontal. The transverse direction Y is the transverse direction Y of the seat. The transverse direction Y of the seat thus corresponds to the transverse Y or lateral direction of the motor vehicle V. This transverse direction Y corresponds to a direction perpendicular to the normal direction of travel of the vehicle V. The transverse direction Y is preferably horizontal. Finally, the vertical direction Z is a vertical direction Z of the seat, perpendicular to the longitudinal and transverse directions.

The modular squab cushion 10 firstly comprises a support frame 20 made of a plastic material. The support frame 20 may comprise a front crossmember 21 and a rear crossmember 22 spaced apart in the longitudinal direction X, and interconnected by a first longitudinal member 23 and a second longitudinal member 23 spaced apart in the transverse direction Y. Each crossmember 21; 22 can extend at least in the transverse direction Y. The front crossmember 21 and the rear crossmember 22 can be substantially parallel to each other. Each longitudinal member 23 can extend at least in the longitudinal direction X. The first longitudinal member 23 and the second longitudinal member 23 may be substantially parallel to each other.

It is understood that the support frame 20 delimits an internal passage 24. The internal passage 24 of the support frame 20 can be delimited longitudinally at the front by the front crossmember 21, and at the rear by the rear crossmember 22. The internal passage 24 of the support frame 20 can be delimited transversely on either side by the first longitudinal member 23 and the second longitudinal member 23.

The modular squab cushion 10 further comprises a suspension member 30 attached to the support frame 20. Because it is attached to the support frame 20, the suspension member 30 is structurally independent of the support frame 20. The suspension member 30 is arranged in whole or in part inside the support frame 20. Expressed differently, the suspension member 30 is, in whole or in part, housed in the internal passage 24 of the support frame 20. An alternative embodiment is not ruled out, wherein the suspension member 30 and the frame 20 are one-piece, notably by being obtained by plastic injection molding in a single operation.

The suspension member 30 is made of a plastic material. According to one embodiment, the frame 20 and the suspension member 30 can each be made of a plastic material. More particularly, the frame 20 and the suspension member 30 can each be made of different materials (for example plastics). For example, the frame can be made of a plastic material with reinforcement, such as fiberglass, and the suspension member 30 can be made of a plastic material without reinforcements.

The use of a support frame 20 made of a plastic material significantly reduces the weight of the seat with respect to traditional metal structures. This weight reduction contributes not only to improving the energy efficiency of the vehicle, but also to facilitating the assembly and handling operations of the seats in the factory. Furthermore, the recesses 41 also help to reduce weight. By lightening the structure while maintaining the suspension and comfort performance, these recesses 41 make it possible to create lighter and more efficient seats, while maintaining adequate strength and durability.

The integration of a suspension member 30 attached to the support frame 20, also made of a plastic material, simplifies the manufacturing process by eliminating the need to assemble metal spring wires and interfaces. The suspension member 30 offers design flexibility which enables the shape and the suspension characteristics to be configured to suit the desired comfort objectives, while retaining a standard support frame 20.

The use of plastic materials for the support frame 20 and the suspension member 30 facilitates recycling at the end of life of the product, thus contributing to a more sustainable and environmentally-friendly approach. In summary, this modular and single-material design reduces the weight and the manufacturing costs, while offering greater recyclability and design flexibility to meet different comfort needs.

Lastly, the suspension member 30 can be replaced independently of the support frame 20, thus allowing easier maintenance and replacement of seat components. This feature not only improves the modularity of the squab cushion, but also its recyclability, making it easier to dismantle, replace and sort materials at the end of life.

The modular squab cushion 10 may therefore lack a metal wire spring system.

The suspension member 30 may comprise a central plate 40 arranged inside the support frame 20. The central plate 40 of the suspension member 30 may have a greater elastic deformability than the support frame 20. Preferably, each recess of the suspension member 30 can be formed through the central plate 40. Thus, the support frame 20 provides the safety and the integrity of the seat in the event of a collision, while the flexible central plate 40 improves the suspension performance and the comfort of the user.

Expressed differently, the central plate 40 of the suspension member 30 has a greater elastic flexibility than that of the support frame 20. Alternatively, the central plate 40 of the suspension member 30 is arranged to be deformed, bent, curved or flexed, preferably reversibly, for example under the load applied by the user of the seat. The term "flexible" or "deformable" refers to the ability of an object to bend, curve or deform without breaking, thus allowing adjustments in its shape or its position. In comparison, a "rigid" object is inflexible and retains its original shape, resisting deformation. In this sense, the central plate 40 of the suspension member 30 may be less rigid than the support frame 20.

Also, the suspension member 30 comprises one or more recesses 41.

The recesses 41 present in the suspension member 30, give this latter, and notably its central plate 40, an increased elastic deformability. Indeed, the recesses 41 allow the mechanical deformation of the suspension member 30 to be controlled. In this sense, these recesses 41 allow the suspension member 30 to bend, curve and deform reversibly under the load applied by the user of the seat. This superior elastic flexibility allows the forces to be absorbed and distributed more effectively, thus improving the comfort and the suspension performance of the seat. Furthermore, the arrangement and the shape of the recesses 41 enable the stiffness and the response of the suspension member 30 to be adjusted based on specific comfort needs, while maintaining a lightweight structure that is easy to manufacture.

The central plate 40 of the suspension member 30 can be elastically deformed so that a transverse axis passing through the hips of a user of the seat has a displacement of less than or equal to 20 mm under a load of a user of 60 to 65 kg with respect to the nominal position (that is before deformation of the central plate 40 under the effect of the load), either dynamically (moving vehicle) or statically (stationary vehicle). This transverse axis is also referred to as the H-point which corresponds to the theoretical pivot point of the hip of an occupant sitting in the seat. It is used as a standard reference for vehicle design, ergonomics and safety testing. In this sense, the H-point represents the approximate location of the hip joint when a person is sitting in a seat.

At least one, and preferably each, of the one or more recesses 41 of the suspension member 30 may be, in whole or in part, through-going. In other words, at least one, and preferably each, of the one or more recesses 41 of the suspension member 30 can form a through-opening in the suspension member.

Alternatively or in addition, at least one, and preferably each, of the one or more recesses 41 of the suspension member 30 may be, in whole or in part, blind. This therefore means that the thickness of the suspension member 30 can be reduced at a blind portion of a recess. An alternative embodiment is not ruled out wherein at least one, and even each, of the one or more recesses 41 comprises at least one through portion and at least one blind portion.

The recesses 41 present in the suspension member 30 may represent between 20% and 80% of the surface area of the central plate 40, more specifically between 20% and 30%, between 30% and 40%, between 40% and 50%, between 50% and 60%, between 60% and 70%, or between 70% and 80%. Such a ratio avoids different pressure zones under the load of a user.

At least one, or even each, of the one or more recesses 41 may have a generally elongated shape in the longitudinal direction X.

The one or more recesses 41 may comprise at least one recess 41a of a first type having a rectangular or square shape.

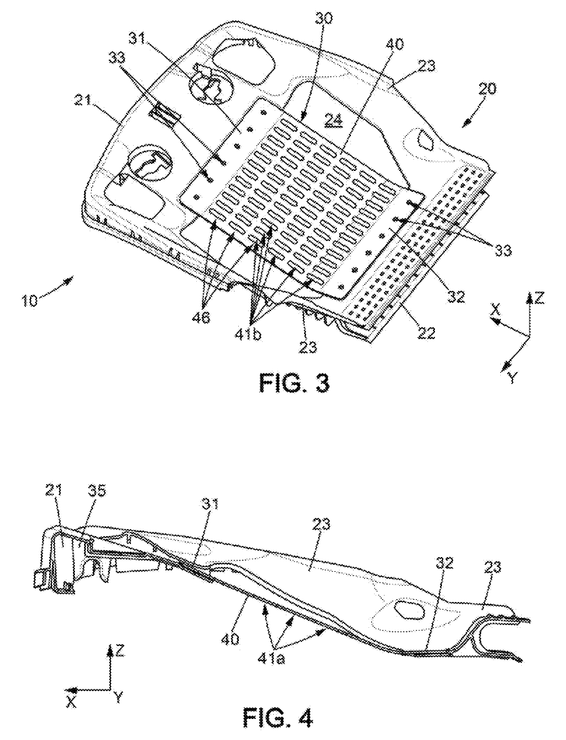

Alternatively or additionally, as shown in FIG. 3, the one or more recesses 41 may comprise at least one recess 41b of a second type having an oblong or oval shape.

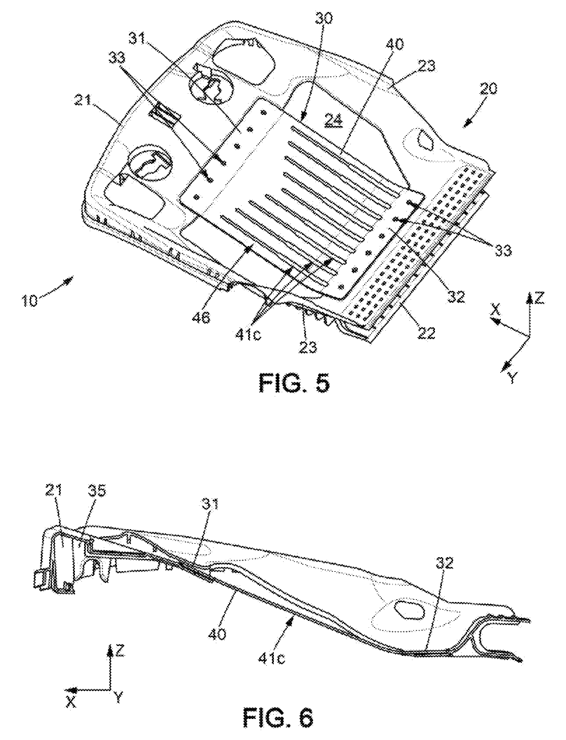

Alternatively or additionally, as shown in FIG. 5, the one or more recesses 41 may comprise at least one recess 41c of a third type which longitudinally comprises a first portion and a second portion, the first portion having a transverse dimension greater than that of the second portion. The first portion and the second portion can each be rectangular or oblong in shape.

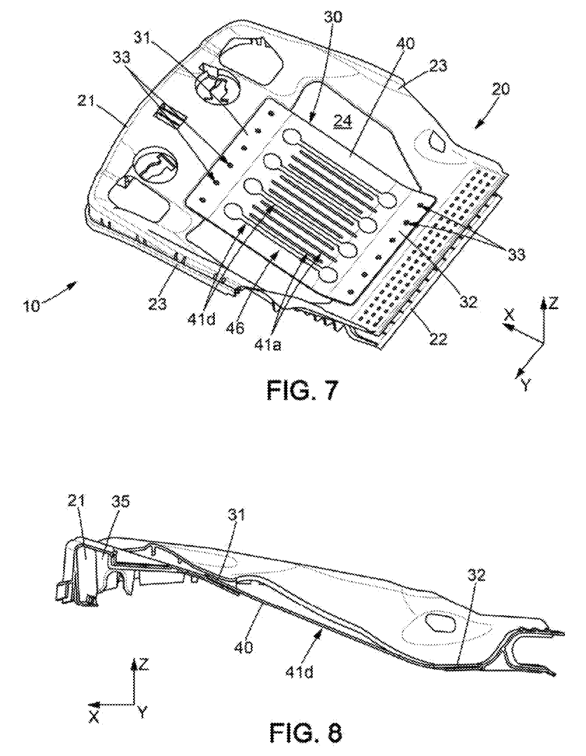

Alternatively or additionally, as shown in FIG. 7, the one or more recesses 41 may comprise at least one recess 41d of a fourth type which comprises front and rear end portions each having a circular or oval shape and a longitudinally elongated central portion. The central portion can therefore be arranged between the front and rear end portions.

At least one, or even each, of the one or more recesses 41 may have several portions of different shapes in the longitudinal direction X. Recesses 41 or portions of recesses 41 having other shapes such as circular, triangular or even polygonal, are not ruled out.

The one or more recesses 41 comprise at least one row 46 of recesses 41, the recesses 41 of the at least one row 46 being arranged one after the other in the transverse direction Y.

As shown in FIG. 3, the one or more recesses 41 may comprise a plurality of rows 46 of recesses 41 arranged successively in the longitudinal direction X. Optionally, the central plate 40 may take the form of a grid in a configuration where the recesses 41 are arranged in a regular pattern.

The recesses 41 in a row 46 may be identical to each other. In this sense, the recesses 41 in a row 46 may have identical longitudinal and transverse dimensions.

Alternatively, the at least one row 46 may comprise mutually different recesses 41.

For example, the row 46 may comprise at least two of the recess 41 of the first type, the recess 41 of the second type, the recess 41 of the third type, the recess 41 of the fourth type. Also, the recesses 41 of the at least one row 46 can form a regular repeating pattern in the transverse direction Y.

According to another example, each recess 41 of the at least one row 46 may have a longitudinal dimension that depends on the transverse position of the recess 41 in the row 46. The longitudinal dimension of the recesses 41 can vary progressively as a function of the transverse position of the recess 41. For example, the recesses 41 located at the transverse ends of the suspension member 30 can have a maximum longitudinal dimension, thus offering a greater flexibility and deformation capacity laterally on each side. Also, the recess(es) 41 located at a transversely median position of the suspension member 30 may have a minimal dimension, providing increased rigidity and a reinforced central support.

The suspension member 30 may comprise one or more mounting lugs 31; 32, by means of which the suspension member is connected to the support frame 20.

At least one, or even each, of the mounting lugs 31; 32 can be connected to the support frame 20 by an attachment component 25 which comprises at least one of: a screw, a rivet, glue, a weld, a clip element (that is a resilient interlocking element), a bolt, a snap-in element. At least one, or even each, of the mounting lugs 31; 32 may comprise holes 33 for attachment to the support frame 20.

At least one, or even each, of the mounting lugs 31; 32 may comprise one or more reliefs each of which cooperates in a complementary manner with a complementary relief on the support frame 20 to provide the attachment of the suspension member 30 to the support frame 20. Each relief may comprise at least one of a protrusion, a notch, a groove or a boss, which fits perfectly with a corresponding relief on the support frame 20. This complementarity of shape provides a solid and precise attachment, preventing any relative movement between the suspension member 30 and the support frame 20. Additionally, this configuration distributes the loads and the stresses uniformly, thus improving the durability and the performance of the seat assembly. The reliefs can also be configured to facilitate assembly and disassembly, making the maintenance and the replacement of components more efficient and less costly.

At least one, or even each, of the mounting lugs 31; 32 can form, in whole or in part, a flat support on the support frame 20, notably configured to prevent a rotation of the suspension member 30 with respect to the support frame 20. This configuration provides a stable and secure attachment, providing that the suspension member 30 remains correctly aligned and functional, even under the load applied by the user of the seat, whether statically (stationary vehicle) or dynamically (moving vehicle).

The one or more mounting lugs 31; 32 of the suspension member 30 may comprise at least one of a front mounting lug 31 by which the suspension member 30 is connected to the front crossmember 21 of the support frame 20, and a rear mounting lug 32 by which the suspension member 30 is connected to the rear crossmember 22 of the support frame 20.

The front mounting lug 31 can be connected to a front end of the central plate 40 of the suspension member 30. The rear mounting lug 32 can be connected to a rear end of the central plate 40 of the suspension member 30.

The central plate 40 of the suspension member 30 can be arranged longitudinally between the front mounting lug 31 and the rear mounting lug 32. The suspension member 30 may be a single piece. In other words, the central plate 40 of the suspension member 30 can be made integral with the front mounting lug 31 and the rear mounting lug 32.

The central plate 40 of the suspension member 30 may comprise one or more folds 44; 45, notably shown in FIGS. 1 and 2. The presence of transverse folds 44; 45 in the central plate 40 of the suspension member 30 increases the flexibility and the elastic deformation capacity of this part. These folds 44; 45 act as flex zones that can bend and curve under the load applied by the user of the seat, thus improving the comfort by absorbing and by distributing the forces more effectively.

At least one, or even each, of the one or more folds 44; 45 may extend transversely edge to edge of the central plate 40. In other words, at least one, or even each, of the one or more folds 44; 45 may extend across the entire transverse dimension of the central plate 40 of the suspension member 30.

At least one, or even each, of the one or more folds 44; 45 extending substantially in the transverse direction Y. A fold 44; 45 extending substantially transversely, is understood to mean a fold 44; 45 extending in a direction that comprises at least one component in the transverse direction Y. Preferably, at least one, or even each, of the one or more folds 44; 45 can extend in the transverse direction Y (that is perpendicular to the longitudinal direction X).

At least one, or even each, of the one or more folds 44; 45 can be V- or U-shaped in cross-section. The V or U shape can be oriented downwards or upwards (that is inverted U or V shape). One section of a fold 44; 45 can be considered in a plane perpendicular to the direction of extension of the fold 44; 45 under consideration. In the case of a fold 44; 45 extending in the transverse direction Y, the section of the fold 44; 45 is considered in a longitudinal plane (that is comprising the longitudinal direction X and the vertical direction Z). The view of the figure corresponds to a cross-sectional view in a longitudinal plane. Also, one section of the folds 44; 45 can be seen in FIG. 2.

The one or more folds 44; 45 may comprise at least a plurality of consecutive folds 44; 45. The folds 44; 45 of the plurality of consecutive folds 44; 45 can be alternatively in opposite directions. Also, two consecutive folds 44; 45 can be S-shaped or even "zigzag" in section. In the example shown in FIGS. 1 and 2, the central plate 40 comprises three consecutive folds. The number of folds, particularly consecutive folds, can be between 1 and 5.

The one or more folds 44; 45 may comprise one or more front folds 44. Each front fold 44 can be arranged longitudinally at a front end of the central plate 40. Each front fold 44 can be longitudinally closer to the front crossmember 21 of the support frame 20 than to the rear crossmember 22 of the support frame 20. The one or more front folds 44 may be consecutive, preferably alternating in opposite directions. The number of front folds 44 can be between 1 and 5, preferably 3.

The one or more folds 44; 45 may also comprise one or more back folds 45. Each rear fold 45 can be arranged longitudinally at a rear end of the central plate 40. Each rear fold 45 can be longitudinally closer to the rear crossmember 22 of the support frame 20 than to the front crossmember 21 of the support frame 20. The one or more rear folds 45 may be consecutive, preferably alternating in opposite directions. The number of back folds 45 can be between 1 and 5, preferably 3.

The one or more folds 44; 45 may comprise, in the longitudinal direction X, one or more front folds 44 and one or more rear folds 45. This configuration provides the uniform deformation of the suspension member 30. This configuration also reduces the pressure concentration points and minimizes the risks of permanent deformation or breakage.

At least one, or even each, of the one or more recesses 41 may be formed at at least one, or even each, of the one or more folds 44; 45.

All or part of the central plate 40 may be curved upwards or downwards. The central plate 40 can be rounded, in whole or in part, upwards or downwards around a transverse axis. Alternatively, with the exception of any folds 44; 45, the central plate 40 can be flat.

The central plate 40 may comprise a front part 42 and a rear part 43. The front part 42 and the rear part 43 of the central plate 40 can form an angle. The front part 42 may be more inclined with respect to the horizontal than the rear part 43, thus providing better support for the legs of the user. The rear part 43 can be curved. Alternatively, the rear section 43 can be inclined or horizontal.

The support frame 20 and/or the suspension member 30 can be made of talc-filled polypropylene, for example with 20% of talc. Talc-filled polypropylene offers excellent rigidity and better dimensional stability, which makes it particularly suitable for applications needing enhanced mechanical performance. By virtue of the addition of talc, it also offers better thermal resistance while maintaining a good balance between lightness and durability. Finally, this material is economical and easily recyclable, making it an ideal solution for sectors such as the automotive industry. For example, the support frame 20 and/or the suspension member 30 can be made of mineral-filled polypropylene.

A seat assembly, in particular for a motor vehicle, is now described referring to FIG. 9.

The seat assembly 100 may comprise the modular squab cushion 10 as described previously. The seat assembly 100 may also comprise a squab structure 101 which comprises two lateral flanges 102 braced by a front tube 103. The support frame 20 is attached to the front tube 103 of the squab structure 101.

The squab structure 101 may further comprise a rear tube 104 transversely bracing the lateral flanges 102. The front tube 103 and/or the rear tube 104 can extend in the transverse direction Y.

In particular, the front crossmember 21 of the support frame 20 can be attached to the front tube 103. To this end, the support frame 20, notably the front crossmember 21, may comprise an attachment component 25, which comprises, for example, at least one of: a clipping element (that is a resilient interlocking element), a snap-fit element.

The support frame 20 can be attached to the rear tube 104 of the squab structure 101. In particular, the rear crossmember 22 of the support frame 20 can be attached to the rear tube 104. To this end, the support frame 20, notably the rear crossmember 22, may comprise an attachment component 25, which comprises, for example, at least one of: a clipping element (that is a resilient interlocking element), a snap-fit element.

Alternatively or additionally, the support frame 20 can be attached to the squab structure 101 by at least one of the following attachment techniques: welding, screwing, riveting and gluing.

The seat assembly 100 may comprise a pad 110 resting on an upper face of the modular squab cushion 10. The upper face of the modular squab cushion 10 can be formed by the support frame 20 and the suspension member 30.

The seat assembly 100 can comprise a trim cover or layer 111 covering the pad 110.

Comparative vehicle seats may have a seat design which uses various components of the seat to be assembled at a site, potentially according to just-in-time manufacturing referred to by the abbreviation “JIT”.

The structure of the comparative seat comprises a seat structure made from metal which comprises a squab structure and a backrest structure.

The comparative seat structure may comprise:

two runners, right and left, each comprising a lower profile, for example female, fixed with respect to a floor, and an upper profile, male, slidably mounted with respect to the lower profile, in a direction X which may be the direction of forward travel of the vehicle,

a squab structure which comprises two flanges, right and left, braced by tubes, and in particular a front tube bracing the flanges, on a front portion of the squab structure and a rear tube bracing the flanges on a rear portion of the squab structure, the front and rear tubes extending in parallel, in a transverse direction,

a metal crossmember which connects front ends of the flanges and is shaped to form a support surface for supporting the squab cushion.

The comparative squab of such a comparative seat comprises a suspension system, or suspension web, with spring wires, connecting the crossmember to a rear part of the squab structure. The comparative squab further comprises a squab pad, for example, made of expanded polyurethane foam, which covers the crossmember and the suspension system and a trim cover over the foam pad.

This comparative configuration has the following disadvantages. Firstly, assembling the spring wires needs a factory operation, which increases the complexity and the cost of production. In addition, to avoid unwanted noise, specific interfaces, often over molded in plastic, should be used to assemble the spring wires to other components of the seat. Not only does this make the seat heavier, but it also increases the manufacturing costs.

Thus, it is desirable to reduce the weight and the cost of vehicle seats while maintaining, or even improving, the safety, the comfort and the suspension function. Such a solution, in accordance with the present disclosure, should also facilitate recycling and offer design flexibility to meet different comfort objectives.

A modular squab cushion is proposed, configured to be attached to a squab structure, the modular squab cushion comprising:

a support frame made of a plastic material, and

a suspension member attached to the support frame and arranged in whole or in part inside the support frame, the suspension member being made of a plastic material and comprising one or more recesses.

The suspension member can comprise a central plate arranged inside the support frame, the central plate of the suspension member having a greater elastic deformability than the support frame, each recess of the suspension member preferably being formed through the central plate.

At least one, and preferably each, of the one or more recesses of the suspension member may be, in whole or in part, through-going.

At least one, or even each, of the one or more recesses may have a generally elongated shape in a longitudinal direction.

The one or more recesses may comprise at least one row of recesses, the recesses of the at least one row being arranged one after the other in a transverse direction.

The suspension member may comprise one or more mounting lugs by means of which the mounting member is connected to the support frame.

The central plate of the suspension member may comprise one or more folds.

At least one, or even each, of the one or more folds may extend substantially in a transverse direction.

The one or more folds may comprise, in a longitudinal direction, at least one of one or more front folds, and one or more rear folds.

The suspension member may be a single piece.

The recesses present in the suspension member may represent between 20% and 80% of the surface area of the central plate, more specifically between 20% and 30%, between 30% and 40%, between 40% and 50%, between 50% and 60%, between 60% and 70%, or between 70% and 80%.

The one or more recesses may comprise at least one recess of a second type having an oblong or oval shape.

At least one, or even each, of the one or more recesses may have a generally elongated shape in the longitudinal direction X.

The one or more recesses may comprise at least one recess of a third type which longitudinally comprises a first portion and a second portion, the first portion having a transverse dimension greater than that of the second portion.

The one or more recesses may comprise at least one recess of a fourth type which comprises front and rear end portions each having a circular or oval shape and a longitudinally elongated central portion.

According to another aspect, a seat assembly is proposed, in particular for a motor vehicle, comprising the modular squab cushion as described above and a squab structure which comprises two lateral flanges braced by a front tube, and wherein the support frame is attached to the front tube of the squab structure.

A modular squab cushion (10) configured to be attached to a squab structure, the modular squab cushion (10) comprising a support frame (20) made of a plastic material, and a suspension member (30) attached to the support frame (20) and arranged in whole or in part inside the support frame (20), the suspension member (30) being made of a plastic material and comprising one or more recesses (41).

1. A modular squab cushion configured to be attached to a squab structure, the modular squab cushion comprising:
a support frame made of a plastic material, and
a suspension member attached to the support frame and arranged in whole or in part inside the support frame, the suspension member being made of a plastic material and comprising one or more recesses.

2. The modular squab cushion of claim 1, wherein the suspension member comprises a central plate arranged inside the support frame, the central plate of the suspension member having a greater elastic deformability than the support frame, each recess of the suspension member preferably being formed through the central plate.

3. The modular squab cushion of claim 1, wherein at least one, and preferably each, of the one or more recesses of the suspension member is, in whole or in part, through-going.

4. The modular squab cushion of 1, wherein at least one, or even each, of the one or more recesses has a generally elongated shape in a longitudinal direction.

5. The modular squab cushion of claim 1, wherein the one or more recesses comprise at least one row of recesses, the recesses of the at least one row being arranged one after the other in a transverse direction.

6. The modular squab cushion of claim 1, wherein the suspension member comprises one or more mounting lugs by means of which the attachment member is connected to the support frame.

7. The modular squab cushion of claim 1, wherein the central plate of the suspension member comprises one or more folds.

8. The modular squab cushion of claim 1, wherein at least one, or even each, of the one or more folds extends substantially in a transverse direction.

9. The modular squab cushion of claim 1, the one or more folds comprise, in a longitudinal direction, at least one of one or more front folds and one or more rear folds.

10. The modular squab cushion of claim 1, wherein the suspension member is a single piece.

11. The modular squab cushion of claim 2, wherein the one or more recesses present in the suspension member represent between 20% and 80% of a surface area of the central plate, more specifically between 20% and 30%, between 30% and 40%, between 40% and 50%, between 50% and 60%, between 60% and 70%, or between 70% and 80%.

12. The modular squab cushion of claim 1, wherein at least one, or even each, of the one or more recesses has a generally elongated shape in the longitudinal direction X.

13. The modular squab cushion of claim 1, wherein the one or more recesses comprises at least one recess of a second type having an oblong or oval shape.

14. The modular squab cushion of claim 1, wherein the one or more recesses comprises at least one recess of a third type which longitudinally comprises a first portion and a second portion, the first portion having a transverse dimension greater than that of the second portion.

15. The modular squab cushion of claim 1, wherein the one or more recesses comprises at least one recess of a fourth type which comprises front and rear end portions each having a circular or oval shape and a longitudinally elongated central portion.

16. A seat assembly, in particular for a motor vehicle, comprising the modular squab cushion according to claim 1, and a squab structure which comprises two lateral flanges braced by a front tube, and wherein the support frame is attached to the front tube of the squab structure.
